(19) United States
(12) Patent Application Publication
(10) Pub. No.: US 2006/0149444 A1
(43) Pub. Date: Jul. 6, 2006

(54) Method of compensating for disturbances in the straight-line stability of a motor vehicle

(76) Inventor: Wolfgang Schindler, Weil der Stadt (DE)

Correspondence Address: KLAUS J. BACH, 4407 TWIN OAKS DRIVE, MURRYSVILLE, PA, 15668, US

(21) Appl. No.: 11/332,602

(22) Filed: Jan. 6, 2006

Related U.S. Application Data
(63) Continuation-in-part of application No. PCT/EP04/07402, filed on Jul. 7, 2004.

(30) Foreign Application Priority Data
Jul. 9, 2003 (DE) 103 30 895.4

(51) Int. Cl. B60G 17/018

(52) U.S. Cl. 701/37; 701/1

(57) ABSTRACT

In a method of compensating for disturbances in the straight-line stability of a motor vehicle which is equipped with an active chassis, and includes a steering wheel angle sensor, a driving speed sensor and a yaw sensor or a transversal acceleration sensor, above a predefined driving speed limit and below a predefined steering wheel angle limit, the actual driving state of the vehicle is determined and, when the driving state deviates from a set-point driving state of the motor vehicle, the axles of the active chassis are braced in a crosswise manner.

This is a Continuation-In-Part Application of International Application PCT/EP2004/007402 filed Jul. 7, 2004 and claiming the priority of German Application 103 30 895.4 filed Jul. 4, 2003.

### BACKGROUND OF THE INVENTION

The invention relates to a method of compensating for disturbances in the straight-line stability of a motor vehicle, which is equipped with an active chassis including a steering wheel angle sensor, a driving speed sensor, a yaw sensor and/or a transversal acceleration sensor.

DE 40 17 222 A1 discloses a method and a system for controlling active suspensions of a motor vehicle. Here, the position of the vehicle is to be improved in order to improve the steering property of the vehicle. For this purpose, a sensor senses the transversal acceleration of the vehicle during cornering. Control valves of the vehicle suspension are actuated by a computational circuit in accordance with the transversal acceleration in order to increase the ground contact load of one wheel and reduce that of another wheel by changing the height of the vehicle.

It is the object of the present invention to provide a means of improved compensation for disturbances in the straight-line stability of a motor vehicle.

### SUMMARY OF THE INVENTION

In a method of compensating for disturbances in the straight-line stability of a motor vehicle which is equipped with an active chassis, and includes a steering wheel angle sensor, a driving speed sensor and a yaw sensor or a transversal acceleration sensor, above a predefined driving speed limit and below a predefined steering wheel angle limit, the actual driving state of the vehicle is determined and, when the driving state deviates from a set-point driving state of the motor vehicle, the axles of the active chassis are braced in a crosswise manner.

In this way it is possible to generate a yaw moment that is opposed to a disturbance in the straight-line stability and reduces the influence of the disturbance or even entirely compensates for it. The advantage of this invention is the use of already known, active chassis systems for compensating for disturbances in straight-line stability without steering interventions being necessary. Such a disturbance is, for example, the occurrence of side wind or of unevennesses in the underlying, that is, the road surface.

The straight-line stability of a vehicle is adversely affected by external disturbances such as unevennesses in road surface and side wind. This adverse effect increases disproportionately as the speed increases. For this reason, suitable compensation for the disturbances in the straightline stability at high speeds is of particular significance.

Active chassis systems such as torsion bars with integrated actuating motors and in some cases also pneumatic suspensions provide the possibility of bracing the wheel loads in a crosswise manner (for example high wheel load front left and rear right and low wheel load front right and rear left) when traveling straight ahead without as a result changing the level, the roll angle or the pitch angle of the vehicle body. This bracing is also imperceptible to the driver.

Further features and feature combinations will become more readily apparent from the following description of embodiments of the invention with reference to the accompanying drawings.

### BRIEF DESCRIPTION OF THE DRAWINGS

FIG. 1 shows a flowchart of the method according to the invention,

FIG. 2 shows conditions of the wheel contact force and torque of the steering axle of a front wheel in a side view, a front view and a top view,

FIG. 3a shows toe-in lateral forces and torques of the steering axle on an unbraced vehicle, and

FIG. 3b shows toe-in lateral forces and torques of the steering axle on a vehicle which is braced according to the invention.

### DESCRIPTION OF PARTICULAR EMBODIMENTS OF THE INVENTION

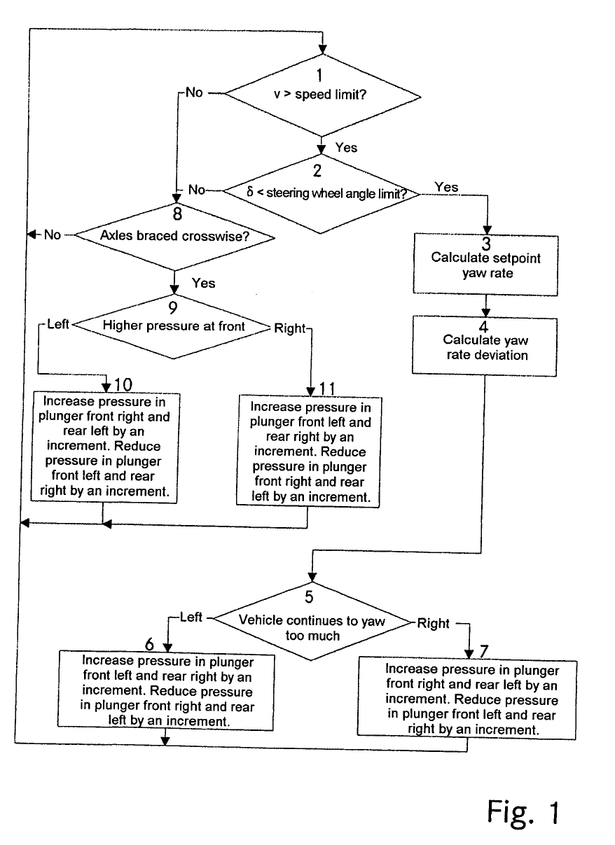

FIG. 1 shows a flowchart of the method according to the invention for activating an active chassis of a motor vehicle. For example vehicles with active stabilizers, vehicles with pneumatic suspension or vehicles with spring-plunger combinations are considered to have an active chassis. The flowchart describes the method according to the invention with reference to a vehicle with spring-plunger combinations. Here, the word plunger is representative of any other possible type of actuator such as, for example, an air spring or the actuator of a stabilizer bar.

An aim of a method according to the invention is to determine deviations in the yaw behavior from the set-point behavior and to counteract such behavior.

Considerations which are explained below show that a change in the wheel contact forces can be used to influence the driving direction of the vehicle in a targeted manner without the need for direct interventions in the steering system.

This possible way of influencing the driving direction of the vehicle is utilized in order to improve the straightline stability of the vehicle at high speeds (for example>150 km/h). For this purpose, the steering wheel angle is observed by means of a steering angle sensor (accuracy typically at least 1°), and the speed is observed by means of an rpm sensor (accuracy typically at least 5 km/h). The set-point yaw rate of the vehicle is calculated from the steering angle, driving speed and the given vehicle values, that is, the wheel base, self-steering, gradient and steering transmission ratio using the single track model.
d psi/dt=v/(I+EG*v²)*delta/i

d psi/dt: setpoint yaw rate [rad/s]

v: speed [m/s]

l: wheel base [m]

EG: self-steering gradient [rad*s²/m]

delta: steering wheel angle [rad]

i: steering transmission ratio [l]

This setpoint yaw rate is compared with the actual yaw rate of the vehicle (for this purpose, for example a yaw rate sensor which is fixed to the bodywork and has an accuracy of at least 0.5°/s is installed in the vehicle). The deviation between the setpoint yaw rate and actual yaw rate is determined. Deviations which occur are generally due to disturbances in the straightline stability as a result of side wind, unevennesses in the ground or inclines of the underlying surface.

These deviations are then minimized by influencing the driving direction as described above using braced axles. The flowchart in FIG. 1 shows the procedure with reference to a preferred embodiment:

Straight-line stability problems occur mainly at high speeds. For this reason, the check as to whether the speed limit (for example 150 km/h) which is defined in the adjustment process is exceeded is carried out first in method step 1. If the speed limit is exceeded, in method step 2 it is checked whether the vehicle is traveling straight ahead. For this purpose it is checked whether the steering wheel angle is smaller than the steering wheel angle limit (for example approximately 5°) defined in the adjustment process. This method step is carried out since the control is not intended to be active when cornering. Bracing the axles when cornering would influence the distribution of the support of the rolling moment between the front axle and rear axle and would thus influence the self-steering behavior of the vehicle.

If both the speed condition from method step 1 and the steering wheel angle condition from method step 2 are fulfilled, the setpoint yaw rate is determined in method step 3 by means of the steering wheel angle signal and the driving speed using the single track model.

In the next method step 4, the difference between the setpoint yaw rate and the actual yaw rate is formed. As a function of the sign of this difference, the plunger pressures were then adjusted by predefined increments (to be defined within the scope of the adjustment) in method step 5 so that a yaw moment is produced which counteracts the difference between the setpoint yaw rate and actual yaw rate. The method then begins again.

If the conditions relating to the speed (method step 1) and/or steering wheel angle (method step 2) are not fulfilled, in method step 8 it is checked whether the axles are still braced from an earlier intervention. If this is the case, in method step 9 it is determined whether the pressure front left or front right is higher. Depending on the result of method step 9, method step 10 or method step 11 then follows. In this context the bracing is reduced by a pressure increment, with the size of the pressure increment to be defined within the scope of the adjustment.

The maximum possible bracing is limited by the maximum available pressures of the active chassis and the maximum plunger travel values (actuator travel values). In principle the loading of the vehicle does not have any influence on the effect of the wheel load control. However, as a result of the higher wheel loads and the level compensation the plungers already have relatively high pressures, and are partially extended, in the normal state, as a result of which the maximum possible bracing of the axles is smaller.

In order to explain the method of operation according to the invention in more detail, a specific example will be illustrated below. The active chassis of an exemplary vehicle is based on hydraulic cylinders (referred to as plungers) which are accommodated in the spring struts and steel springs which are connected in series. The plunger position is defined by 0 mm in the construction position of the vehicle. From this position, it can be extended by 40 mm on the front axle and retracted by −45 mm. On the rear axle 50 mm and −70 mm are possible. The spring stiffness values are 200 N/mm on the front axle and 150 N/mm on the rear axle. The spring strut transmission ratios (ratio between the wheel compression and spring strut travel) are 1.8 both on the front axle and on the rear axle.

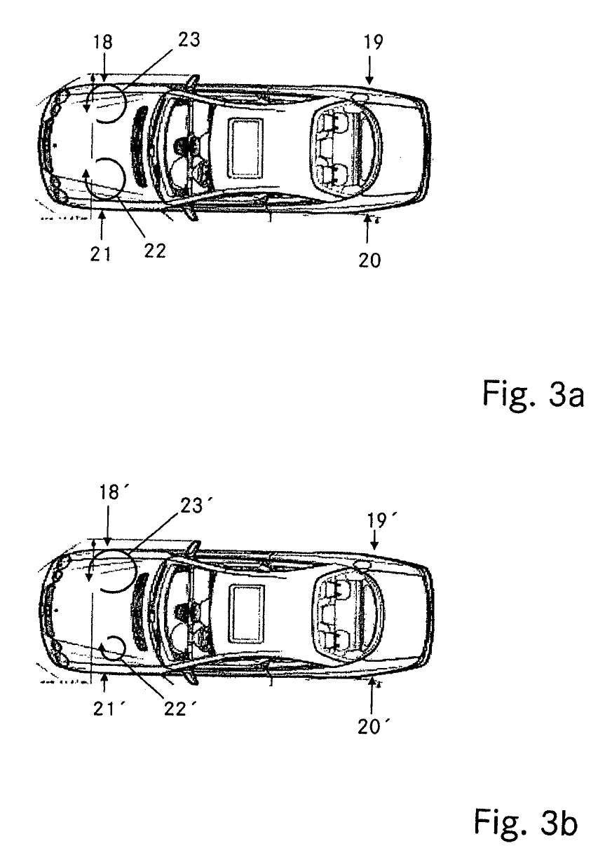

The wheel loads between the right- and left-hand sides are distributed symmetrically (FIG. 3a) so that the following state is obtained:

| | Front axle load: | Rear axle load: |
|---|---|---|
| | 1050 kg | 1000 kg |
| Right-hand: | Front right: | Rear right: |
| 1025 kg | Wheel load: 525 kg | Wheel load: 500 kg |
| | Plunger: 0 mm | Plunger: 0 mm |
| | Spring: 0 mm | Spring: 0 mm |
| | Level: 0 mm | Level: 0 mm |
| | Wheel contact force | Wheel contact force |
| | (24): | (24): |
| | 5150 N | 4905 N |
| Left-hand: | Front left: | Rear left: |
| 1025 kg | Wheel load: 525 kg | Wheel load: 500 kg |
| | Plunger: 0 mm | Plunger: 0 mm |
| | Spring: 0 mm | Spring: 0 mm |
| | Level: 0 mm | Level: 0 mm |
| | Wheel contact force | Wheel contact force |
| | (24): | (24): |
| | 5150 N | 4905 N |

The axles can then be braced crosswise by means of the plungers. If in this context the plungers are retracted axle by axle on one side as well as extended on the other side and at the same time the resulting differences in wheel contact force between the wheels of one axle for the front axle and for the rear axle are the same, the position of the body (roll angle, pitch angle and level) does not change.

Extension of the left-hand rear wheel plunger by, for example, 20 mm when the position of the body is not changed results in compression of the spring by 20 mm and thus in an increase in the spring force by 20 mm×150 N/mm=3000 N. 3000 N additional spring force results in an additional wheel contact force of 3000 N/1.8=1670 N. The right-hand rear wheel plunger is correspondingly retracted by 20 mm so that the reverse effect is obtained here, that is to say a decrease in the wheel contact force by 1670 N. This thus results in a difference in the wheel contact forces at the rear axle of 3340 N.

In order to ensure an unchanged position of the body, this difference must also be set at the front axle. For this purpose, the plungers are also to be moved here in such a way that the spring forces change by 3000 N in each case. Owing to the harder springs at the front axle, plunger adjustments of 3000 N/200 N/mm=15 mm are sufficient, with the left-hand front wheel plunger being retracted and the right-hand one being extended.

The vehicle is then in the following state (FIG. 3b):

| | Front axle load: | Rear axle load: |
|---|---|---|
| | 1050 kg | 1000 kg |
| Right-hand: | Front right: | Rear right: |
| 1025 kg | Wheel load: 695 kg | Wheel load: 330 kg |
| | Plunger: +15 mm | Plunger: −20 mm |
| | Spring: −15 mm | Spring: +20 mm |
| | Level: 0 mm | Level: 0 mm |
| | Wheel contact force: | Wheel contact force: |
| | 6820 N | 3235 N |
| Left-hand: | Front left: | Rear left: |
| 1025 kg | Wheel load: 355 kg | Wheel load: 670 kg |
| | Plunger: −15 mm | Plunger: +20 mm |
| | Spring: +15 mm | Spring: −20 mm |
| | Level: 0 mm | Level: 0 mm |
| | Wheel contact force: | Wheel contact force: |
| | 3480 N | 6575 N |

It is apparent that despite a massive change in the wheel contact forces the sum of the wheel contact forces of the wheels at the front axle and the sum at the rear axle has remained the same compared to the initial state. The sum of the left-hand wheels and the sum of the right-hand wheels have not changed either.

This effect influences the yaw of the vehicle (rotation about the Z axis) in two different ways.

1. Axles usually have a toe-in angle setting. This toe-in angle setting results in an inwardly directed side force on the tire. Given a total toe-in angle of 0.5°—that is to say a toe-in angle for each wheel of 0.25°—a toe-in lateral force (18, 19, 20, 21) of 300 N is obtained with a skew stiffness of 1200 N/°. The following conditions are obtained for the initial example:

| | | |
|---|---|---|
| Right-hand: | Front right: | Rear right: |
| 1025 kg | toe-in lateral | toe-in lateral |
| | force 300 N | force 300 N |
| | directed to left | directed to left |
| Left-hand: | Front left: | Rear left: |
| 1025 kg | toe-in lateral | toe-in lateral |
| | force 300 N | force 300 N |
| | directed to right | directed to right |

The toe-in lateral forces (18, 19, 20, 21) cancel one another out and there is thus no yaw movement of the vehicle. The vehicle travels straight ahead if the steering system is in a straight-ahead position.

However, the skew stiffness of the tire changes approximately proportionately to the wheel contact force in large ranges. In the example with adjusted plungers, the wheel contact forces at the front axle have been adjusted in each case by 32% at the front axle and in each case by 34% at the rear axle. As a result, an increase in the toe-in lateral forces at the wheels with extended plunger of approximately 100 N should be assumed, and a decrease in the toe-in lateral forces (18′, 19′, 20′, 21′) at the wheels with an extended plunger of approximately 100 N should be assumed (FIG. 3b). The following state is obtained for the example:

| | | |
|---|---|---|
| Right-hand: | Front right: | Rear right: |
| 1025 kg | toe-in lateral | toe-in lateral |
| | force 400 N | force 200 N |
| | directed to left | directed to left |
| Left-hand: | Front left: | Rear left: |
| 1025 kg | toe-in lateral | toe-in lateral |
| | force 200 N | force 400 N |
| | directed to right | directed to right |

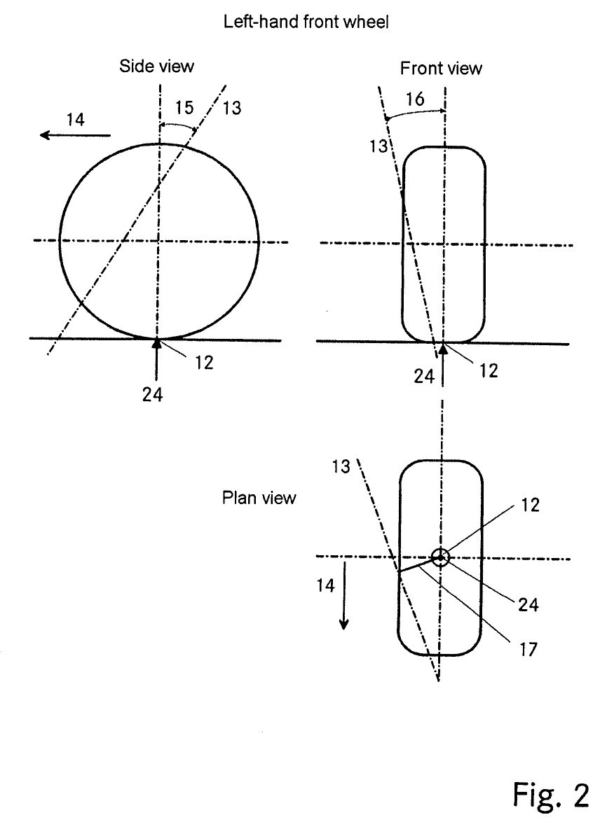

The change in the wheel contact forces when the wheels on the front axle are in the straight-ahead position thus results in a toe-in lateral force of 200 N directed to the left at the front axle, and a toe-in lateral force of 200 N directed to the right at the rear axle. A wheel base of 3 m thus results in a yaw moment about the vertical axis 600 Nm to the left. A moment of inertia about the vertical axis of 4200 kgm² results in a yaw angle acceleration of 0.14 rad/s², corresponding to 8.2°/s² to the left. When disturbances occur in the straight-line stability, yaw angle rates of less than 4°/s usually occur. These can accordingly be compensated for with the forces available here within 0.5 s, thus more quickly than by the driver. It is necessary to allow here for the fact that significantly larger travel values and thus forces can also be made available by means of the plungers.
2. At the front axle the wheel load adjustment has a second effect. Virtually every vehicle has a caster angle (15) at the front axle (inclination of the steering axle (13) of the front wheel in the X-Z plane) to the rear and a steering inclination angle (16) (inclination of the steering axle (13) of the front wheel in the Y-Z plane) to the inside. The conditions at the left-hand front wheel are illustrated schematically in FIG. 2.

In FIG. 2, it is apparent in the plan view that the steering axle (13) of the wheel is laterally offset with respect to the wheel contact point (12). The right-angled distance between the wheel contact point (12) and the steering axle (13) is the lever arm (17) of the wheel contact force (24). The proportion of the wheel contact force (24) which acts at right angles to the steering axle (13) results, in conjunction with the lever arm (17), in a moment about the wheel steering axle (13) which is directed inward. The angle alpha between the steering axle (13) and underlying surface is calculated from:
alpha=arcsin (1/(tan²(caster angle)+tan²(steering angle inclination)+1)^{0.5})

Given a caster angle (15) of 10° and a steering angle inclination (16) of 5°, an angle between the steering axle (13) and the underlying surface with alpha=790 is accordingly obtained.

The proportion of the wheel contact force (24) which acts at right angles to this axle (13) is calculated from:
F_{RL}=F_{R}×cos alpha

The cosine of 79° is 0.19. Accordingly, in this example 19% of the wheel contact force (24) acts at right angles to the steering axle (13).

Given a wheel contact force (24) of 5150 N, this is 980 N. Given a lever arm (17) of 50 mm, this results in a torque of 49 Nm. For the initial state described above, the following conditions are thus obtained (FIG. 3a):

| | Front axle load: | Rear axle load: |
|---|---|---|
| | 1050 kg | 1000 kg |
| Right-hand: | Front right: | Rear right: |
| 1025 kg | Wheel load: 525 kg | Wheel load: 500 kg |
| | Wheel contact force | Wheel contact force |
| | (24): 5150 N | (24): 4905 N |
| | Torque about steering | |
| | axle (23): | |
| | 49 Nm to left | |
| Left-hand: | Front left: | Rear left: |
| 1025 kg | Wheel load: 525 kg | Wheel load: 500 kg |
| | Wheel contact force | Wheel contact force |
| | (24): 5150 N | (24): 4905 N |
| | Torque about steering | |
| | axle (22): | |
| | 49 Nm to right | |

In this state, the torques (23, 22) which act on the steering axles of the two front wheels cancel one another out. They thus have no influence on the steering of the vehicle or on the driving behavior. The only effect which the steering torques have is to increase the track rods forces on both sides.

The situation is different if the axles are braced with respect to one another, as in the previous example (FIG. 3b):

| | Front axle load: | Rear axle load: |
|---|---|---|
| | 1050 kg | 1000 kg |
| Right-hand: | Front right: | Rear right: |
| 1025 kg | Wheel load: 695 kg | Wheel load: 330 kg |
| | Wheel contact force | Wheel contact force |
| | (24): 6820 N | (24): 3235 N |
| | Torque about steering | |
| | axle (23′): | |
| | 65 Nm to left | |
| Left-hand: | Front left: | Rear left: |
| 1025 kg | Wheel load: 355 kg | Wheel load: 670 kg |
| | Wheel contact force | Wheel contact force |
| | (24): 3480 N | (24): 6575 N |
| | Torque about steering | |
| | axle (22′): | |
| | 33 Nm to right | |

In this case, the torque values (23′, 22′) no longer cancel one another out. The torque (23′) with left-hand rotation of the right-hand front wheel is twice as large as the torque (22′) with right-handed rotation of the left-hand front wheel. On the one hand, if the steering wheel is being held tightly this causes the steering system to be rotated within the scope of the elasticity so that a slight left-handed steering lock will occur at the wheels. On the other hand, a torque which can also be perceived in the steering wheel, and which attempts to turn the steering wheel to the left, results from the differential torque at the wheels.

Both the steering effect which results from the toe-in lateral force (18′, 19′, 20′, 21′) and the steering effect which results due to the torques (22′, 23′) of the steering axle both act in the same direction (to the left in the example).

1. A method of compensating for disturbances in the straight-line driving stability of a motor vehicle which is equipped with an active chassis, including a steering wheel angle sensor, a driving speed sensor and a yaw sensor or a transversal acceleration sensor, comprising the steps of: at a vehicle speed in excess of a predefined driving speed and below a predefined steering wheel angle, determining the actual driving state of the vehicle and, when the driving state deviates from a set-point driving state of the motor vehicle, bracing the axles of the active chassis in a crosswise manner.

2. The method as claimed in claim 1, wherein the axles are braced crosswise such that the level of the vehicle is retained.

3. The method as claimed in claim 1, wherein
the set-point yaw rate of the vehicle is determined from the steering wheel angle, the driving speed and further vehicle constants,
the actual yaw rate is compared with the set-point yaw rate and any deviation of the actual value of the yaw rate from the set-point value is determined, and
the active chassis is activated in accordance with the deviation in the yaw rate.

4. The method as claimed in claim 1, wherein below a predefined driving speed limit and above a predefined steering wheel angle limit, the bracing of the axles is reduced.
